(19) United States
(12) Patent Application Publication
(10) Pub. No.: US 2026/0350683 A1
(43) Pub. Date: Nov. 5, 2026

(54) PROVIDING RECOMMENDATIONS BASED ON A HETEROGENEOUS GRAPH

(71) Applicant: Intuit Inc., Mountain View, CA (US)

(72) Inventors: Wendi CUI, Jersey City, NJ (US); Damien J. LOPEZ, San Diego, CA (US); Vipin KUMAR, Bengaluru (IN); Palak SAMEL, San Diego, CA (US); Joel D. ATWOOD, San Diego, CA (US); Jiaxin ZHANG, Mountain View, CA (US)

(21) Appl. No.: 19/195,614

(22) Filed: Apr. 30, 2025

(51) Int. Cl. G06Q 30/0601

(52) U.S. Cl. CPC G06Q 30/0631

(57) ABSTRACT

Certain aspects of the disclosure relate to methods for providing recommendations based on a heterogenous graph comprising a set of user nodes and a set of channel nodes. Methods include identifying a subset of channel nodes that are connected to a target user node in a graph and identifying a subset of user nodes among the set of user nodes. For each respective user node of the subset of user nodes, a user relevance weight is determined based on a number of channel nodes in the subset of channel nodes to which the respective user node is connected. For each respective channel node of the subset of channel nodes, a channel relevance weight is determined based on the user relevance weight associated with each respective user node that is connected to the respective channel node. A channel recommendation is generated for a target user associated with the target user node.

### BACKGROUND

### Field

Aspects of the present disclosure relate to recommendation services.

### Description of Related Art

All around the world, the Internet continues to transform how individuals connect with others and share information. With its growing influence on individuals and large economies alike, the Internet has become a vital part of people's everyday lives. While the number of Internet users continues to grow year-over-year, so does the volume of information made available online. In fact, according to latest estimates (2023), about 300 million terabytes of data are created each day. While there are benefits to sharing information over the internet, including an ability to reach a wider audience, the explosive growth in the amount of available information has created an information overload problem for online users.

Information overload is a state of being overwhelmed by the amount of data presented for one's attention and/or processing. The term is used to refer not only to situations involving too much data for a given decision, but also the constant inundation of data from many sources. Information overload reduces an online user's capacity to function effectively, which can lead to poor decision making and/or an inability to make decisions, as well as can hinder timely access to items of interest on the Internet.

A strategy for preventing information overload is intentionally limiting the amount of online information exposure by being selective about the type and/or amount of data presented to users over the Internet. Recommendation services (also referred to as “recommender engines”) are example information filtering systems that help to limit the amount of online information exposure. In particular, recommendation services are able to provide recommendations in real-time.

Recommendation services are beneficial to both service providers and users. For example, recommendation services may help to reduce transaction costs of finding and/or selecting items in an online shopping environment. In e-commerce settings, recommendation services may help to increase company revenues, for example, in cases where the recommendation services are effective in means of selling more products. Further, in some cases, recommendation services may help users discover items they might not have found otherwise.

### SUMMARY

One aspect provides a method for providing recommendations based on a heterogenous graph representing users and channels associated with a communication service. The method includes identifying a subset of channel nodes that are connected to a target user node in a graph, the graph comprising: a set of user nodes including the target user node, a set of channel nodes including the subset of channel nodes, and a plurality of edges connecting one or more of the set of user nodes to one or more of the set of channel nodes; identifying a subset of user nodes among the set of user nodes, wherein each user node of the subset of user nodes is connected to at least one channel node of the subset of channel nodes via at least one edge of the plurality of edges; determining, for each respective user node of the subset of user nodes, a user relevance weight based on a number of channel nodes in the subset of channel nodes to which the respective user node is connected; determining, for each respective channel node of the subset of channel nodes, a channel relevance weight based on the user relevance weight associated with each respective user node that is connected to the respective channel node; and generating a channel recommendation for a target user associated with the target user node, wherein the channel recommendation is based on the channel relevance weight associated with each channel node of the subset of channel nodes.

Another aspect provides a method for providing recommendations based on a heterogenous graph comprising a plurality of nodes of a plurality of different node types. The method includes obtaining a graph comprising a set of nodes comprising: a plurality of first nodes of a first type including a target node, a plurality of second nodes of a second type, and a plurality of edges connecting one or more of the plurality of first nodes to one or more of the plurality of second nodes; generating, for each respective node of the set of nodes in the graph, a set of node weights, wherein each respective node weight of the set of node weights is based on a respective property of a plurality of properties associated with the respective node; generating, for each respective second node of the plurality of second nodes, a relevance score based on the set of node weights associated with the respective second node and one or more sets of node weights associated with one or more first nodes connected to the respective second node; and generating a node recommendation for a target user associated with the target node, wherein the node recommendation is based on the relevance score associated with each respective second of the plurality of second nodes.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example process flow for ranking and sorting relevant user channels for a target user.

FIG. 2 depicts an example computing environment implementing an example graph-based recommendation service.

FIG. 3 depicts examples of a user recommendation and a channel recommendation for a target user.

FIG. 4 depicts example channel nodes associated with a target user node.

FIG. 5 depicts example user nodes that share at least one channel node connection with the target user node.

FIG. 6 depicts an example set of top k user nodes relative to the target user node.

FIG. 7 depicts an example set of top k channel nodes relative to the target user node.

FIG. 8 depicts an example flowchart associated with a method for providing recommendations based on a heterogenous graph.

FIG. 9 depicts another example flowchart associated with a method for providing recommendations based on a heterogenous graph.

FIG. 10 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

As described above, recommendation services can be used to help prevent information overload by filtering and/or limiting information being presented to users. Recommendation services have become important components across different domains including e-commerce, entertainment, social media, news, and professional services. Recommendation services can enhance the user experience, increase engagement, and drive conversion rates by reducing information overload and providing a focused set of information to users.

Two broad categories of recommendation services include general recommendation services and personalized recommendation services. General recommendation services provide general recommendations based on population-wide trends or editorial curation. General recommendation services typically rely on aggregate metrics across a large population, such as popularity metrics, recency metrics, or categorical classification to generate recommendations that appeal to a broad audience. While such approaches benefit from simplicity and transparency, general recommendation services are unable to accommodate diverse preferences exhibited across a user population, often resulting in recommendations that are not relevant to individual users.

Personalized recommendation services generate personalized recommendations based on predicting user's preferences or interests for items, content, or actions. Personalized recommendation services attempt to address the limitations of general recommendation services by leveraging user-specific data to generate user-tailored suggestions. Personalized recommendation services operate through algorithmic processing of datasets to identify patterns, similarities, and correlations that enable personalized suggestions for individual users. Personalized recommendation services function by collecting user data, building user and entity profiles, identifying relationships between users and entities, and then generating recommendations based on the profiles and identified relationships.

Some personalized recommendation services may leverage one or more graphs (e.g., referred to herein as “graph-based recommendation services”). For example, a graph used by such services may include multiple interconnected nodes and edges, where each node represents an entity, such as an item or a user. Each edge may be used to connect a respective pair of nodes, thereby representing a relationship and/or an interaction between the respective pair of nodes. By analyzing the structure of these graphs, a graph-based recommendation service may be capable of more easily identifying patterns and efficiently making predictions about which nodes of the graph may be more relevant in generating recommendations. For example, a graph-based recommendation service may leverage the connectedness of entities (represented as nodes) to infer similarities and discover potential recommendations that might not be apparent when using traditional methods.

PageRank®, developed by Google®, is one example of an algorithm that may be used by a graph-based recommendation service to provide recommendations. Specifically, PageRank® is designed to rank nodes within a graph (e.g., a graph comprising multiple nodes connected by multiple edges) based on their importance, considering the connections (e.g., edges) between the nodes in the graph. The algorithm may assume that a node connected to a greater number of other nodes in the graph, especially other nodes that are determined to be highly important (e.g., highly ranked) themselves, is more important than a node with less connections and/or with connections to nodes that are determined to be less important in the graph. For example, with PageRank®, each node in the graph may distribute its current importance value proportionally across its outgoing connections to other nodes in the graph. PageRank® may then assign a numerical weight of importance to a specific node in the graph based on the importance values from incoming connections/nodes. The nodes may then be ranked based on their corresponding importance values, and recommendation(s) may be generated based on this ranking.

By using a graph to organize entities in a recommendation domain, graph-based recommendation services are capable of representing complex relationships between entities, such as to provide more accurate and personalized recommendations. Further, such services may be capable of providing recommendations with reduced resource consumption (e.g., in terms of memory and compute). For example, the organization of the nodes in the graph may allow for easier and more efficient analysis than analyzing the raw data. Although graph-based recommendation services provide the aforementioned technical advantages, such services are not without limitations. For example, a technical problem associated with the use of graph-based recommendation services is their inability to consider properties associated with different nodes in the graph when making recommendations, thereby overlooking information which may be valuable for effective recommendation generation. For example, such services may treat all nodes uniformly and rely on link structure alone. As another technical problem, existing graph-based recommendation services may weight all node connections equally regardless of when they were formed. As such, these services may be able to discount older relationships and/or emphasize recently created relationships between nodes, making them incapable of adapting to evolving user preferences over time.

As another technical problem, existing graph-based recommendation services may treat all edges between nodes as being of the same type and therefore fail to differentiate between various types of node connections that signal different types of entity relationships and/or interactions, which may be important information to consider for the generation of effective recommendations. For example, existing graph-based recommendation services may treat a user-user node connection as the same as a user-channel node connection, when the edges in each different type of connection represent a different relationship between entities. Ineffective recommendations provided by existing graph-based recommendation services to a user may, in some cases, adversely impact the user's trust and acceptance of such services. Additionally, graph-based recommendation services may experience the “cold-start” problem, where meaningful recommendations cannot be generated for new entities represented in the graph because they have limited relationship and/or interaction history as represented by the graph nodes and edges. Accordingly, techniques are needed for improving recommendations predicted by a graph-based recommendation service.

Aspects described herein overcome the aforementioned technical problems and improve upon the state of the art by providing an improved graph-based recommendation service that is designed to provide personalized recommendations based on a property-driven node importance algorithm applied to a heterogeneous graph. A heterogeneous graph is a graph including nodes associated with multiple node types. For example, the graph-based recommendation service described herein may utilize a heterogeneous graph comprising multiple interconnected nodes and edges. Each node in the heterogeneous graph may represent a different entity, and each edge in the heterogeneous graph may represent a relationship between different entity pairs. When providing recommendations, the graph-based recommendation service may consider different types of nodes and/or properties associated with each node in the heterogeneous graph. For example, in some aspects when providing a recommendation for a target entity represented as a target node in the graph, the graph-based recommendation service may generate node weights based on the node types and node properties of one or more other nodes in the graph and further use the nodes weight to generate a ranking of the nodes. The ranking may generate a sorted list of nodes associated with entities that may be recommended to the target entity based on their relevance and/or importance to the target entity. Beneficially, in some aspects, the ranking may be generated without having historical interaction data between the different users and channels.

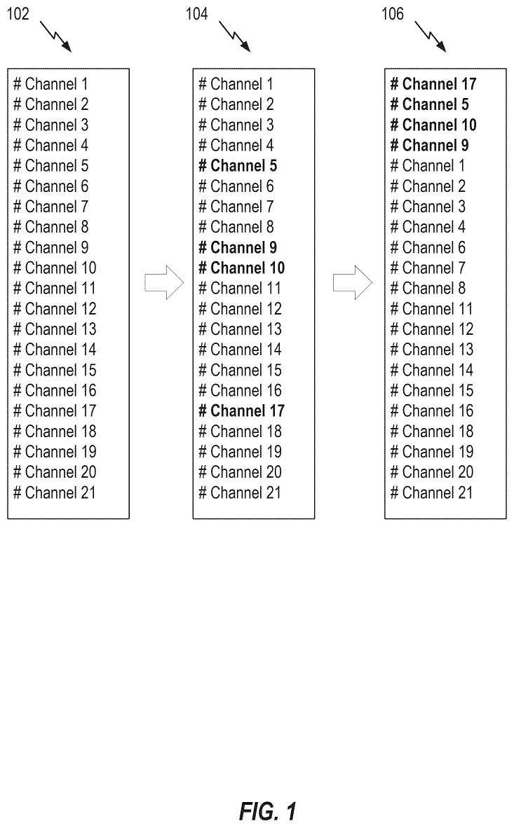

In certain aspects, the graph-based recommendation service described herein may be utilized by search engines, social media platforms, and/or communication services (to name a few) for the purpose of generating recommendations. For example, FIG. 1 depicts example use of the disclosed graph-based recommendation service to generate recommendation(s) for a target user of a communication service. As used herein, a “communication service” refers to a service that connects users for the purpose of exchanging information. For example, a communication service may enable a user to communicate with one or more other users by transmitting and receiving information through various communication channels, where a communication channel (simply referred to herein as “channels”) refers to a medium or pathway designed for the passage of information. More specifically, a channel may be a communication medium that allows a user to send and/or publish messages and/or content to other users, as well as receive and interact with messages and/or content from the other users.

In the example shown in FIG. 1, the target user may utilize a communication service to exchange information with a large number of users and via a large number of channels. In the course of several hours, the target user may find hundreds of notifications of new interactions, from multiple users and via multiple channels, to review. It may be difficult for the target user to ascertain which interactions to review and respond to first; thus, in this example, channel recommendation(s) may be generated by the graph-based recommendation service to aid the user in making this decision. As used herein, a “channel recommendation” may be a suggestion, made by the graph-based recommendation service, of one or more channels that the target user is recommended to check, as these suggested channels may be determined to be the most relevant to the user at the current moment. The graph-based recommendation service described herein may be used in place of conventional unread priority schemes (e.g., used to rank channels based on which channels have the most unread messages) and/or timestamp priority schemes (e.g., used to rank channels based on which channels have the most recent messages published), which exist to provide similar channel recommendations for the target user. While these schemes may be useful to help a target user identify which channels are relevant and/or important to the user at a smaller scale, such schemes may not be the most effective way for a user to discern which channels to review and participate in first, especially in cases where the number of channels and/or messages to be reviewed by the target user is particularly large.

As shown, FIG. 1 depicts an example list of channels 102 (e.g., available channels including channels 1-21) that are currently used and/or may be used by the target user to communicate with other users of the communication service.

In this example, the disclosed graph-based recommendation service may be used to identify a sublist of the channels 104 that are most relevant to the target user, such as the sub-list of channels 104 (e.g., channels 5, 9, 10, and 17, which are identified in bold type from among the list of channels 102). The most relevant channels, e.g., the sub-list of channels 104, may then be filtered to the top of the list of channels 102, as illustrated in channel set 106, thereby providing a recommendation to the target user that these channels are recommended to the target user. In this manner, the graph-based recommendation service may enable the target user to visually identify which channels to review first, such as opposed to having to enter and review messages in each channel to identify the channels that are the most relevant to the target user.

Although FIG. 1 illustrates an example of modifying a channel list to reflect a channel recommendation for a target user, it is noted that in some other examples, the graph-based recommendation service may additionally, or alternatively, be used to generate user recommendation(s) for the target user of the communication service. A user recommendation may be a suggestion, made by the graph-based recommendation service, of one or more users of the communication service that the target user is recommended to interact with (e.g., such as next in time).

The graph-based recommendation service described herein provides significant technical advantages over conventional graph-based recommendation services, including providing more accurate and/or effective recommendations due to at least an ability of the service to (1) adapt to evolving user preferences over time, (2) consider properties associated with different nodes in the graph when making recommendations, and (3) distinguish between different types of edges and take this information into consideration when making recommendations. The ability to adapt to evolving user preferences over time may be attributed to the generation of node weights when generating recommendations, where the node weights are based on node properties associated with user and channel activity, including recency and frequency of such activity. The ability to consider properties associated with different nodes in the graph when making recommendations may be attributed to generating nodes of different node types, such as user nodes, channel nodes, etc., wherein the graph-based recommendation service is able to identify different node properties based on the node type. Additionally, while current graph-based recommendation services treat all edges as having equivalent semantic meaning and therefore fail to differentiate between various types of node connections that signal different types of user-item interactions, the graph-based recommendation service described herein beneficially distinguishes between different types of edges, such as user-user connections, user-channel connections, or channel-channel connections. This allows for a node to be weighted, not only based on its node type, but also based on the types of other nodes with which the node is connected.

Notably, aspects of the graph-based recommendation service described herein overcome the “cold-start” problem because new entities can be added into the graph structure and weighted without having to have historical interaction data. For example, a new user (e.g., an example entity) can be determined relevant to a target user based on how many channels the new user and the target user are members of, without having to wait for the new user to actually publish data in the channel or interact with the target user in another manner. A member of the channel is a user who has access to the channel, can interact with other users within the channel, and can publish content and messages to the channel. In another example, a new user can be determined to be relevant to a target user based on a relationship between the new user and the target user, such as a being on the same team, participating in the same project, or a supervisor-employee relationship.

While aspects herein are described with respect to the use of the graph-based recommendation service by a communication service, such as to provide user and/or channel recommendation(s) to a target user of the communication service, it is noted that the graph-based recommendation service described herein may be similarly utilized by other services and/or in various other applications to provide recommendations while enjoying the same technical benefits discussed herein.

### Example System Implementing a Graph-Based Recommendation Service in a Communication Service

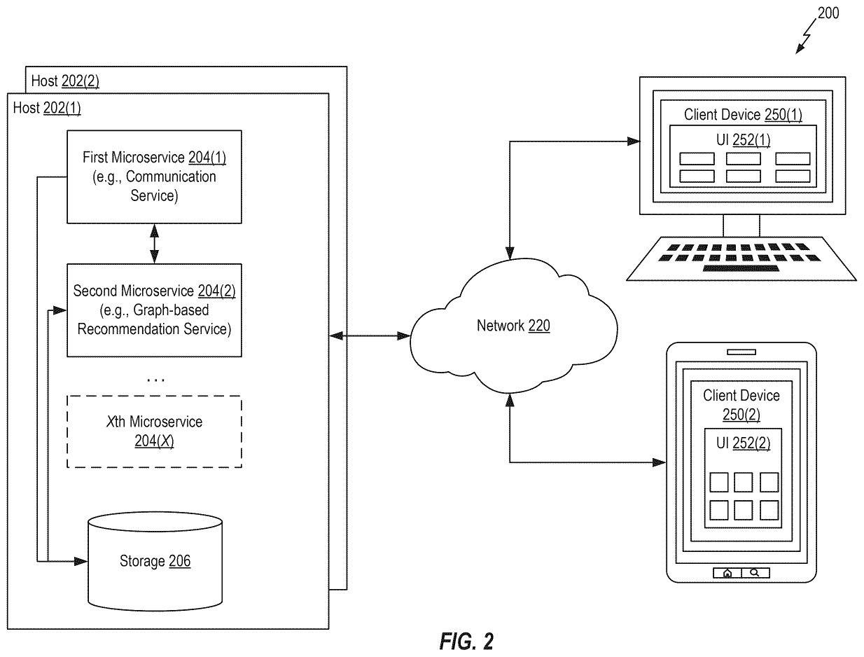

FIG. 2 depicts an example system 200 supporting a plurality of microservices 204 (e.g., software-defined services, which in some cases, may be cloud-native). As shown in FIG. 2, system 200 includes client devices 250(1)-(2) (collectively referred to herein as “client devices 250”) and hosts 202(1)-(2) (collectively referred to herein as “hosts 202”) interconnected through a network 220. Network 220 may be, for example, a direct link, a local area network (LAN), a wide area network (WAN), such as the Internet, another type of network, or a combination of one or more of these networks.

Host 202 may be geographically co-located servers on the same rack or on different racks in any arbitrary location in a data center. Host 202 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 206, and other components (e.g., only storage 206 is shown in FIG. 2).

A first host 202(1) in system 200 may host a plurality of microservices 204(1)-(X) (collectively referred to herein as “microservices 204”), where X is an integer greater than one. The microservices 204 may be deployed using virtual machines (VMs) and/or container(s) running on first host 202(1) (e.g., where first host 202(1) is running a hypervisor (not shown) used to abstract processor, memory, storage, and networking resources of first host 202(1)'s hardware platform). Generally, microservices 204 are loosely coupled and independently deployable services (or software) that may make up an application. Microservices 204 may enable segmented, granular level functionalities within a larger system infrastructure.

Client device 250(1) and client device 250(2) may each include a user interface (UI) 252(1), 252(2), respectively, which may be used to communicate with, at least, a first microservice 204(1) and/or another microservice 204, through the X-th microservice 204(X) using the network 220. For example, communication between client devices 250 and a microservice 204 may be facilitated by one or more application programming interfaces (APIs). Examples of client devices 250 may include a smartphone, a personal computer, a tablet, a laptop computer, and/or other devices.

As shown in FIG. 2, in certain aspects, the first microservice 204(1) implements a communication service, which is any network 220 accessible service that maintains user profiles and provides means, such as communication channels, chatrooms, and/or messaging services, for effecting communication between users associated with the various user profiles. Some example communication services include Slack®, Messages®, Facebook® Messenger®, Instagram® Direct Messages, and/or email, to name a few. In certain aspects, the communication service stores its data in storage 206.

In certain aspects, the second microservice 204(2) implements a graph-based recommendation service. The graph-based recommendation service may be a service used to identify relevant user(s) and/or relevant channel(s) for a target user associated with the communication service. For example, in certain aspects, the graph-based recommendation service may use one or more techniques (e.g., such as techniques for filtering and/or scoring, described herein) to weight and rank different users to identify one or more relevant users for the target user. A respective user is relevant to a target user when the interactions with the respective user have higher priority than interactions with another user based on one or more relationships to the target user. For example, a user may be more relevant when the user is on the same team as the target user, on the same project as the target user, is a direct or higher superior of the target user, and/or when the user has asked the target user to complete specific tasks or vice versa, to name a few. A user may become more relevant to the target user as the user forms a higher number of relationships with the target user. In some aspects, the relationships between the user and target user can be more important than others. For example, a relationship based on the user being in the same company as the target user may be less important than a relationship based on the user being the direct supervisor of the target user.

As another example, in certain aspects, the graph-based recommendation service may use one or more techniques (e.g., such as techniques for filtering and/or scoring, described herein) to weight and rank different channels to identify one or more relevant channels for the target user. A channel may be relevant to a target user when interactions with the channel have higher priority than interactions with another channel. In some aspects, a channel may be relevant to the target user when the channel comprises content and/or messages with which the target user wants to interact with. In some aspects, a target user wants to interact with the channel based on interest(s) and/or based on some obligation(s) of the target user. For example, regarding the target user's interest(s), the channel may comprise announcements about optional social activities in which the target user may be interested in joining. As another example, regarding the target user's obligation(s), the channel may comprise updates and status reports on a project with an upcoming deadline that the target user is working on. In some aspects, a channel may be relevant to a target user based on what other users are interacting with the channel. In particular, a channel may become more relevant as increasing numbers of users, relevant to the target user, begin interacting with the channel.

In certain aspects, the graph-based recommendation service may be used to generate a heterogenous graph that represents the users and channels associated with the communication service as nodes, as well as the relationships (or interactions or connections) between the users and channels as edges. As described in more detail below, the graph-based recommendation service may utilize the heterogeneous graph, and more specifically the edges generated between nodes representing the users and channels, as well as the properties associated with each of the nodes in the graph, to determine weights and rank the different users and/or channels for generating one or more recommendations.

Though FIG. 2 depicts each of first host 202(1), storage 206, client device 250(1), and client device 250(2) as single devices for ease of illustration, first host 202(1), storage 206, client device 250(1), and/or client device 250(2) may be embodied in different forms for different implementations. Further, though FIG. 2 depicts only two hosts 202 and two client devices 250, other examples may include more or fewer hosts 202 and/or client devices 250, and client devices 250 may use any combination of microservices 204 on any host 202 where microservices 204 are deployed.

### Example User and Channel Recommendations

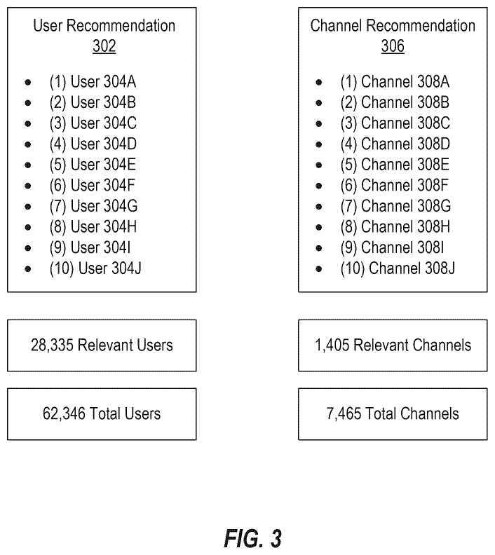

FIG. 3 depicts examples of a user recommendation 302 and a channel recommendation 306 that may be generated for a target user using the graph-based recommendation service described herein. In some aspects, a target user of a communication service may want to know which user(s) of the communication service are relevant to the target user and/or which channel(s) of the communication service are relevant to the target user. For example, there may exist a large number of users associated with the communication service, but only a subset (e.g., less than all) of these users may be relevant to the target user. Similarly, there may exist a large number of channels associated with the communication service, but only a subset of these channels may be relevant to the target user. In some aspects, user and/or target relevance may be determined on a scale, with some users and/or channels being more relevant to the target user than other users and/or channels, such that users and/or channels of the communication service are ranked according to how relevant they are to the target user.

Example user recommendation 302 shown in FIG. 3 includes a subset of users of (all users of) the communication service that are most relevant to the target user, including user 304A, user 304B, user 304C, user 304D, user 304F, user 304G, user 304H, user 304I, and user 304J. In some aspects, as shown in FIG. 3, the subset of users is ranked by relevance to the target user as a Top 10 subset of users, with user 304A associated with a first ranking position (e.g., ranked as number 1) and user 304J associated with a tenth ranking position (e.g., ranked as number 10). In some other aspects, however, user recommendation 302 may comprise any number of relevant users, for example, a Top 3, Top 5, Top 20, or Top 100, such as depending on the preference of the target user, the number of relevant users, and/or a number of total users associated with the communication service. As shown in the example in FIG. 3, the total number of users associated with the communication service is 62,346 users, the number of relevant users to the target user is 28,335 users, and a Top 10 subset of the relevant users is presented in a ranked list as part of user recommendation 302.

Example channel recommendation 306 shown in FIG. 3 comprises a subset of channels that are most relevant to the target user, including channel 308A, channel 308B, channel 308C, channel 308D, channel 308E, channel 308F, channel 308G, channel 308H, channel 308I, and channel 308J. In some aspects, as shown in FIG. 3, the subset of channels is ranked by relevance to the target user as a Top 10 subset of channels, with channel 308A associated with a first ranking position (e.g., ranked as number 1) and channel 308J is associated with a tenth ranking position (e.g., ranked as 10). Channel recommendation 306 may comprise any number of relevant channels, for example a Top 3, Top 5, Top 20, or Top 100, such as depending on the preference of the target user, the number of relevant channels, and/or number of total channels associated with the communication service. As shown in FIG. 3, the total number of channels associated with the communication service is 7,465 channels, the number of relevant channels to the target user is 1,405 users, and a Top 10 subset of the relevant channels are presented in a ranked list as part of channel recommendation 306.

### Recommendations Based on a Heterogenous Graph

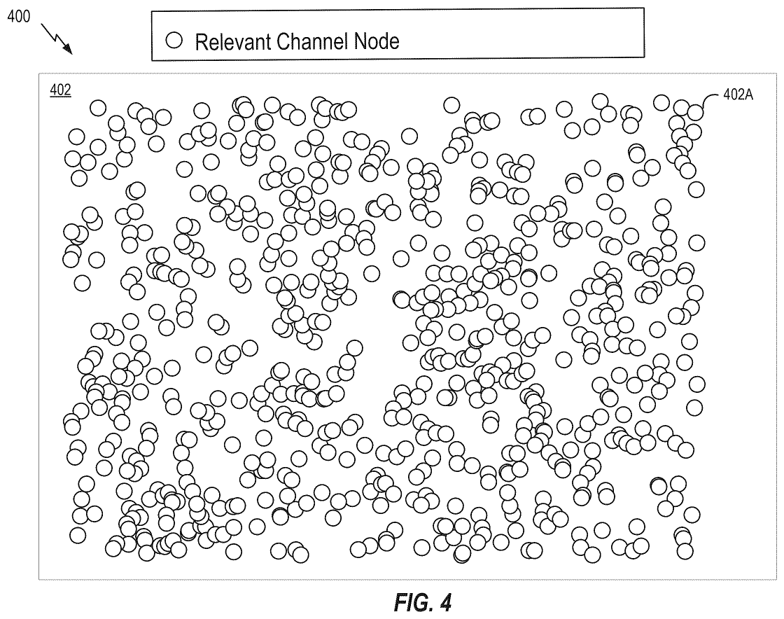

The following descriptions related to FIGS. 4-7 depict various views of a heterogenous graph based on identifying, within the graph, relevant user nodes and relevant channel nodes for a target user. A relevant user node is a node that represents a relevant user for the target user. Similarly, a relevant channel node is a node that represents a relevant channel for the target user. In some aspects, the relevant user nodes are used to generate a user recommendation, such as user recommendation 302 depicted in FIG. 3. In some aspects, the relevant channel nodes are used to generate a channel recommendation, such as channel recommendation 306 depicted in FIG. 3. In some aspects, a list of channels displayed to a target user may be updated based on the generated channel recommendation, as illustrated in FIG. 3.

### Identifying Relevant Channel Nodes

The identification of relevant channel nodes may involve identifying a subset of channel nodes that are connected to a target user node in a graph. This identification facilitates the identification of channels, represented by relevant channel nodes, relevant to a target user, represented by the target user node. The graph may include (1) a set of user nodes, including the target user node, and (2) a set of channel nodes, including the subset of channel nodes that are connected to the target user node in the graph. Each channel node may represent a channel associated with the communication service, and each user node may represent a user associated with the communication service. The target user node may represent a target user. The graph may also include a plurality of edges connecting one or more user nodes of the set of user nodes to one or more of the set of channels nodes. For example, a first edge may be used to connect a first user node to a second user node in the graph, and/or a second edge may be used to connect the first user node to a first channel node in the graph. In some aspects, a user node may be connected to a channel node based on a user, corresponding to that user node, participating in the channel and/or being a member of the channel associated with the channel node.

FIG. 4 depicts an example graph view 400 of a subset of channel nodes 402, which includes relevant channels nodes for a target user. The subset of channel nodes 402 includes a subset of all channel nodes in the heterogeneous graph. The subset of channel nodes 402 shown in FIG. 4 may include channel nodes identified via the graph-based recommendation service described herein. As shown, each channel node (e.g., channel node 402A) of the subset of channel nodes 402 is represented by an open circle.

Notably, a channel node may be connected to a target user node when a target user, corresponding to the target user node, is a member of and/or participates in the channel corresponding to the channel node. In some aspects, a channel node may be connected to a target user node when a target user, corresponding to the target user node, has published at least one message in a channel corresponding to the channel node. In some aspects, a channel node may be connected to a target user node when a target user, corresponding to the target user node, is a creator of the channel.

In one example, the subset of channel nodes 402 shown in FIG. 4 may represent the 1,405 relevant channels identified in FIG. 3.

### Identifying Relevant Users

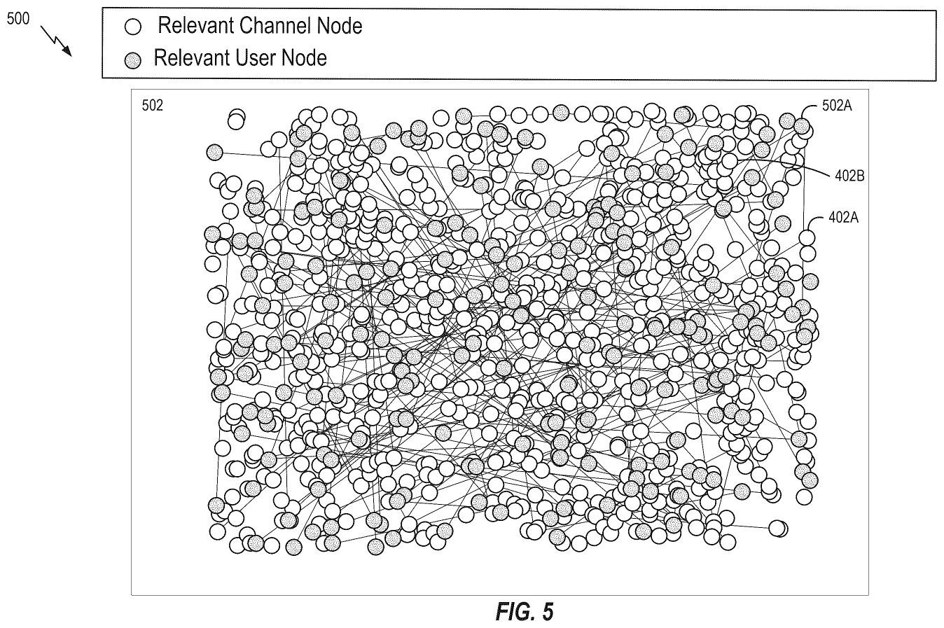

In order to identify relevant users for a target user, the graph-based recommendation service analyzes the connections between user nodes and channel nodes of the heterogenous graph to determine whether a particular user, as represented by a particular user node, is relevant to a target user, as represented by a target user node. Accordingly, FIG. 5 depicts an example graph view 500 of a subset of user nodes 502, which includes relevant user nodes. More specifically, FIG. 5 adds to the graph view 400 shown in FIG. 4 by further displaying the example subset of user nodes 502 in addition to the subset of channel nodes 402. The subset of user nodes 502 shown in FIG. 5 may include user nodes 502 identified via the graph-based recommendation service described herein. In FIG. 5, each user node (e.g., user node 502A) of the subset of user nodes 502 is represented by a stipple-shaded circle. Graph view 500 also depicts a plurality of edges that show how user nodes of the subset of user nodes 502 are connected to channel nodes of the subset of channel nodes 402.

Each user node 502 of the subset of user nodes may be associated with the target user. In some aspects, a user node may be associated with a target user node, corresponding to the target user, based on the user node being connected to at least one channel node of the subset of channel nodes 402 (e.g., such as via at least one edge in the heterogeneous graph). In other words, a user node may be associated with a target user node where the user, corresponding to the user node, is a member of and/or participates in the same channel as the target user corresponding to the target user node. In some aspects, a user node may be associated with the target user node when the user, corresponding to the user node, is on the same team, same project, at the same company, and/or has a same or similar job title as the target user, corresponding to the target user node.

In one example, the subset of user nodes 502 shown in FIG. 5 may represent the 28,335 relevant users identified in FIG. 3.

### Determining User Relevance Weights

After identifying the subset of channel nodes 402 and the subset of user nodes 502, the graph-based recommendation service may determine a user relevance weight for each respective user node 502 of the subset of user nodes 502. The user relevance weight is used to determine how relevant a user node is to a target user node, with some relevant user nodes identified in subset of user nodes 502 having higher or lower relevance to the target user node. Thus, in some aspects, when identifying the subset of user nodes 502, the graph-based recommendation service determines a binary output of relevant or not relevant based on whether the user node is connected to at least one channel node to which the target user node is connected. In order to generate a ranking of the subset of user nodes 502, the graph-based recommendation service determines relevance of a particular user to the target user based on a user relevance weight for the user node corresponding to the particular user. This type of relevance weighting helps to capture the concept that a user is likely to be more relevant to the target user if the user is in more of the same channels as the target user than other users. For example, if the target user is only in one channel with another user, that user may not be as relevant to the target user as a user who participates in ten or more of the same channels as the target user.

In some aspects, the user relevance weight associated with a respective user node may be determined based on a number of channel nodes 402 in the subset of channel nodes 402 (e.g., shown in FIG. 4 and FIG. 5) to which the respective user node is connected in the heterogeneous graph. As described above, a user node may be connected to a channel node in the heterogeneous graph when a user, corresponding to the user node, is a member of, participates in, or is otherwise associated with a channel corresponding to the channel node. Thus, in some aspects, the user relevance weight for a respective user node may be based on a number of channels the user corresponding to the respective user node shares with the target user corresponding to the target user node. A user may “share” a channel with the target user when the user and target user both are members of, participate in, and/or are otherwise associated with the same channel. As an example, user node 502A, as shown in FIG. 5, is connected to channel node 402B of the subset of channel nodes 402. As mentioned above, each channel node of the subset of channel nodes 402 is connected to a target user (not shown). Thus, user node 502A and the target user node “share” channel node 402B. Accordingly, the user relevance weight may be based on the channel nodes which are connected to both the user node and the target user node, which connections represent the channels that the target user and user share.

Regarding the user relevance weight, a user node (e.g., in the subset of user nodes 502) corresponding to a user that shares more channels with the target user than another user may be assigned a higher user relevance weight than the user node (e.g., in the subset of user nodes 502) corresponding to the other user.

In some aspects, a user relevance weight determined for a respective user node 502 of the subset of user nodes 502 may be based on one or more types of relationships between a user associated with the respective user node 502 and the target user. These relationships can be determined based on analyzing one or more node properties, such as company, job title, team name, length of time employed at the company, or other relationship information stored as one or more node properties. For example, users who are on more of the same teams as the other target user may be more relevant, and thus assigned a higher relevance weight, to the target user than other users who are only on one, who are not any of the same teams, as the target user. As another example, users who are higher up in the corporate hierarchy and/or who have direct or indirect supervision over the target user may be more relevant than users who share similar roles as the target user.

### Set of Top k Relevant User Nodes

In some aspects, the graph-based recommendation service described herein may use the user relevance weights determined for the subset of user nodes 502 to generate a ranking for the subset of user nodes 502. For example, user nodes associated with higher user relevance weights may be ranked higher than user nodes associated with lower user relevance weights. In some aspects, the graph-based recommendation service may generate a user recommendation, such as user recommendation 302 of FIG. 3, for the target user based on this ranking. For example, the user recommendation may be based on a list of users corresponding to one or more user nodes of the subset of user nodes 502 that belong to a top k number of user nodes based on the ranking (e.g., where k is an integer greater than 0).

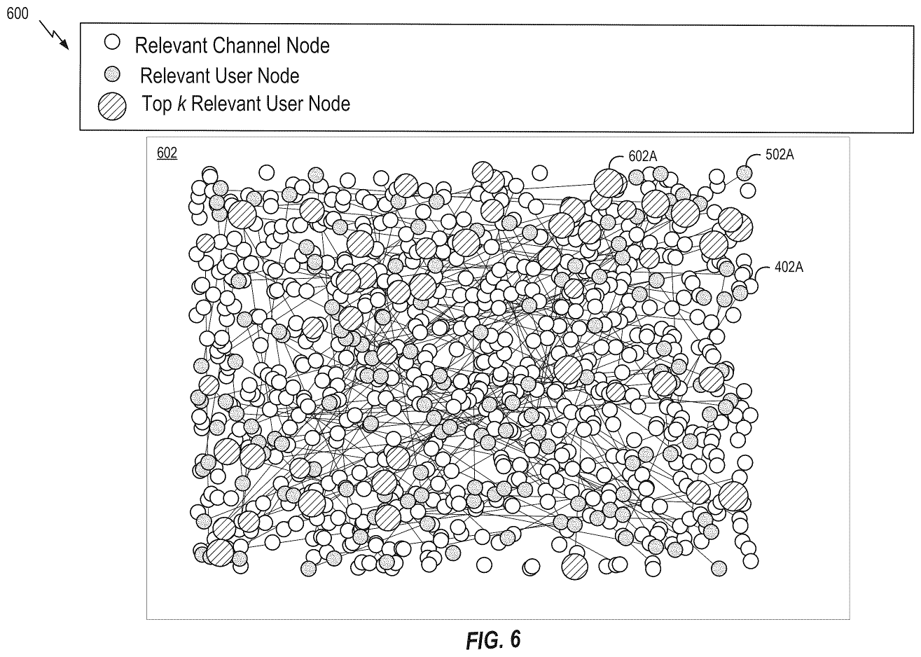

FIG. 6 depicts an example graph view of a set of top k user nodes 602, in the subset of user nodes 502, which are relevant to the target user referenced in FIG. 4 and FIG. 5. More specifically, FIG. 6 adds to the graph view 500 shown in FIG. 5 by further differentiating the set of top k user nodes 602 from other user nodes 502 in the subset of user nodes 502. The set of top k user nodes 602 shown in FIG. 6 may include user nodes identified via the graph-based recommendation service described herein. As shown in FIG. 6, each user node (e.g., user node 602A) of the set of top k user nodes 602 is represented by a diagonally hatched circle. Each user node of the set of top k user nodes 602 is represented by varying radii based on the corresponding user relevance weight, with higher user relevance weights being represented by larger radii.

In some aspects, the user relevance weight of each user node of the set of top k user nodes 602 represents a number of channels shared with the target user such that the user nodes associated with higher numbers of shared channels are represented with larger radii than user nodes associated with lower numbers of shared channels.

### Set of Top k Relevant Channel Nodes

After identifying the subset of user nodes 502 and determining a user relevance weight for each respective user node of the subset of user nodes, the graph-based recommendation service is configured to determine a channel relevance weight for each channel node of the subset of channel nodes 402. Based on the channel relevance weight associated with each respective channel node, the graph-based recommendation service is configured to rank the subset of channel nodes 402 and determine a channel recommendation, such as channel recommendation 306 of FIG. 3, for the target user. In some aspects, the channel recommendation comprises a set of top k channel nodes relative to the target user node, where k is a positive integer. In some aspects, the channel recommendation and the user recommendation comprise the same number of top k entities. Alternatively, the channel recommendation may comprise a different number of channels (e.g., top k channels) than the user recommendation comprises users (e.g., top z users, where z is a positive integer).

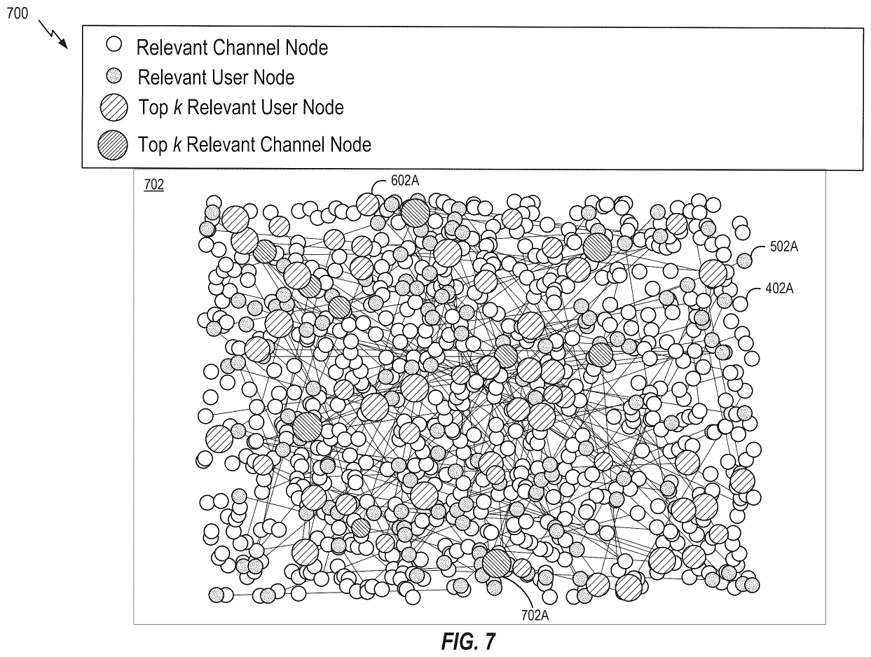

Accordingly, FIG. 7 depicts an example graph view 700 of a set of top k channel nodes 702. More specifically, FIG. 7 adds to the graph view 600 shown in FIG. 6 by further displaying the set of top k channel nodes 702 in addition to the set of top k user nodes 602. The set of top k channel nodes 702 may include channel nodes identified via the graph-based recommendation service described herein. In FIG. 7, each channel node (e.g., node 702A) of the set of top k channel nodes 702 is represented by a diagonally hatched circle. The radius of each circle is used to represent the value of the channel relevance weight, such that larger radii are associated with higher channel relevance weights.

In some aspects, the channel relevance weight of each channel node of the set of top k channel nodes 702 is based on the user relevance weight associated with each respective user node of the subset of user nodes 502. Thus, in some aspects, the channel relevance weight for a respective channel node is based on a combination of all user relevance weights associated with the set of user nodes connected to the respective channel node. As shown in FIG. 7, channel nodes associated with higher channel relevance weights are represented with larger radii than channel nodes associated with lower channel relevance weights. In this manner, although a certain channel node may have more user nodes connected to the certain channel node than another channel node, the certain channel node may still have a lower channel relevance weight than the other channel node if the other channel is connected to user nodes with higher user relevance weights.

In this manner, the graph-based recommendation service is able to provide a channel recommendation, such as channel recommendation 306 of FIG. 3 to the target user based on the set of top k channel nodes 702 relative to the target user. Accordingly, the graph-based recommendation service may then cause a version of the available channel list to be displayed at a user interface, with the set of top k channels corresponding to the set of top k channel nodes filtered to the top of the channel list, as shown in channel set 106 of FIG. 1.

In some aspects, the graph-based recommendation service determines one or more additional node weights for the nodes in the heterogenous graph to help identify relevant users and relevant channels for a target user. In particular, the graph-based recommendation service is configured to identify one or more node properties associated with each node and generate additional node weights based on the different node properties. These node-property-based node weights help to further refine and increase the accuracy of identifying relevant users and channels and providing corresponding recommendations. Beneficially, a combination of the various node weights may be used to determine the user relevance weight and/or channel relevance weight. In some aspects, the node weights are normalized as part of determining the user relevance weight and/or channel relevance weight to prevent some nodes from being disproportionately weighted as compared to other nodes in the heterogeneous graph.

### Privacy Node Weights

In some aspects, the graph-based recommendation service may determine a privacy weight based on a privacy level associated with a respective node. For example, the channel may be a direct message channel associated with a particular user and/or group of users selected by the target user. A direct message channel may be associated with a high level of privacy. The channel may be a private channel with access restricted to a particular set of users associated with the communication service. The private channel may be associated with a medium level of privacy.

Alternatively, the channel may be a public channel available to any users associated with the communication service. A public channel may be associated with a low level of privacy. A channel node corresponding to a higher level of privacy will be weighted with a higher privacy weight than a channel corresponding to a lower level of privacy. In terms of relevance to a target user, the graph-based recommendation service may associate higher levels of privacy with an indication that the channel is more relevant to the target user than a channel with lower levels of privacy. For example, a target user may want to review and respond to messages in a direct message channel prior to reviewing and messages in a public channel, which may not need immediate attention. Thus, in some aspects, when the graph-based recommendation service determines and analyzes privacy weights for channel nodes, the channel relevance weight for each respective channel node is further based on the privacy weight.

### Activity/Recency Node Weights

In some aspects, the additional node weight(s) determined for the nodes in the heterogeneous graph may include activity and/or regency weights. For example, the graph-based recommendation service may determine, for one or more channel nodes in the heterogeneous graph, one or more activity and/or recency weights. In some aspects, an activity weight determined for a channel node may be based on a frequency of message activity within a channel corresponding to the channel node. In some aspects, a recency weight and/or a timestamp of a latest message or other interaction published to the channel. In some aspects, the channel relevance node is further based on one or more of the activity and/or recency weights. For user nodes, one or more activity and/or recency weights may be determined based on the user's recent login frequency, last active time, or other activity or recency property associated with the user's activity within the communication service. In some aspects, the user relevance node is further based on one or more of the activity and/or recency weights.

### Normalizing Node Weights

In some aspects, when using a combination of weights to determine a user relevance weight for a user node and/or a channel relevance weight for a channel node, one or more of the node weights in the combination may be normalized prior to determining the user relevance weight and/or the channel relevance weight. For example, a privacy weight, activity weight, recency weight, or the user relevance weight may need to be normalized in order to determine an accurate channel relevance weight for a respective channel node. Normalization of the node weights may be performed such that a node weight for a particular node does not disproportionately outweigh other node weight(s) associated with other nodes when determining similar metrics.

In some aspects, node weights may be normalized by node degree, such a degree of separation (e.g., 1^{st} degree, 2^{nd} degree, etc.). A 1^{st} degree refers to a direct connection between nodes, such as a target user node directly connected to a respective user node. A 2^{nd} degree refers to an indirect connection, or connection through another node, such as a target user node directly connected to a first user node which is then connected to a channel node. Thus, the channel node would have a 2^{nd} degree node connection with the target user node.

In some aspects, node weights may be normalized from the target user node or by membership size. For example, nodes weights for channel nodes may be normalized such that a channel node associated with a channel having large membership sizes (e.g., a large number of users utilize this channel) is not disproportionately weighted in favor of relevance to a user compared to other channel nodes.

As an illustrative example, a channel node corresponding to a public channel that is capable of being utilized by all the users associated with a communication service may be disproportionately weighted, through any one of the aforementioned node weights, compared to at least a channel node corresponding to a direct message channel that is capable of being utilized by only two users of the communication service. However, the channel node corresponding to the direct message channel may actually be more relevant to a target user, represented as a target user node in the graph, than the channel node corresponding to the public channel. Normalization techniques described herein may be used to address/fix this weighting such that the graph-based recommendation service is not always inclined to identify the channel node corresponding to the public channel as a more relevant channel node to the target user node than other channel nodes associated with channels capable of being utilized by a lesser number of users.

### Extrinsic Data Nodes

In some aspects, in addition to the user nodes and channel nodes described above, a graph used by the graph-based recommendation service described herein may further include one or more extrinsic data nodes. An extrinsic data node included in the heterogeneous graph may represent extrinsic data associated with the communication service. Examples of such extrinsic data may include document(s), email(s), project timeline(s) and/or deadline(s), user data, channel data, and/or other types of similar data.

In some aspects, extrinsic data represented by an extrinsic data node in the graph may be related to a particular user, such as when a user is the creator or owner of the extrinsic data (e.g., owner or creator of a document, an email, etc.). Extrinsic data represented by an extrinsic node in the graph may be related to a channel. For example, an extrinsic node may represent an email that is attached to a message published in a specific channel (e.g., represented as a channel node in the graph). In order to represent such relationships between extrinsic data nodes, user nodes, and channel nodes, the graph may include extrinsic edge(s) connecting the extrinsic data node(s) to one or more of the channel nodes and/or to one or more of the user nodes.

When utilizing graphs comprising user nodes, channel nodes, and extrinsic data nodes, the graph-based recommendation service may be designed to identify a set (e.g., all or less than all) of extrinsic data nodes (e.g., such as among all extrinsic data nodes included in the graph) that are connected to the target user node. Then, for each respective channel node of the subset of channel nodes (e.g., such as the subset of channel nodes 402 shown in FIG. 4), the graph-based recommendation service may determine an extrinsic data weight based on a number of extrinsic data nodes in the set of extrinsic data nodes, which are also connected to each respective channel node. In some aspects, the graph-based recommendation service determines the channel relevance weight, at least in part, based on the extrinsic data weight for each respective channel node. For example, a channel node may have a channel relevance weight that is based in part on the user relevance weights(s) associated with one or more user nodes connected to the channel node and based in part on the extrinsic data weight(s) associated with one or more extrinsic data nodes that are connected to the channel node. In this manner, the relevance of the channel is determined based on how many and which users are connected to the target user node and the channel node, as well as how many and which extrinsic data nodes are connected to the target user node and the channel node.

By considering the extrinsic data weights, the graph-based recommendation service is able to determine a more accurate and comprehensive channel relevance weight because information about extrinsic data included in the channel may help the graph-recommendation service better determine if the channel is relevant to the target user. For example, if the channel includes project documents that the target user has accessed, it may be an indication that the channel is more relevant than another channel where the target user has not accessed any of the project documents included in the other channel.

### Property-Driven Node Importance Algorithm

In some aspects, an algorithm for providing recommendations via the graph-based recommendation service may be represented by one or more functions. For example, a heterogenous graph (G) used by the graph-based recommendation service for providing user and/or channel recommendation(s) may be represented as:

G=(N,E)

where N is the set of nodes, including user nodes and channel nodes, and E is the set of edges connecting pairs of nodes (e.g., representing connections between users and/or channels associated with the pairs of nodes, including for example, user-user connections, user-channel connections, and channel-channel connections). In some aspects, the heterogenous graph (G) may include one or more additional types of nodes, included in the set of nodes (N), such as extrinsic data nodes, which are described in detail below. Further, corresponding edges between the additional types of nodes, user nodes, and channel nodes may be included as part of the set of edges (E).

The graph-based recommendation service may determine which channels are most relevant to a target user (u) based on the graph (G) and, in some cases, properties associated with different nodes in the set of nodes (N). In some aspects, node properties analyzed by the graph-based recommendation service may include type-based properties based on the different types of nodes in the set of nodes (N). For example, example node types associated with a node in the set of nodes (N) may include a user node type, a channel node type, or another node type.

The graph-based recommendation service may determine which channels are most relevant to a target user (u) based on the graph (G) and, in some cases, weights associated with different nodes in the set of nodes (N). Regarding channel nodes, a privacy weight may be determined based on whether the channel is private, public, or a direct message. Regarding user nodes, a user relevance weight may be determined based on a scoring index that measures a user's role, impact, seniority, and/or other relevance to a target user, such as shared channels with the target user. In some aspects, one or more node properties are based on an activity or recency associated with a channel or user associated with a respective node.

In some aspects, the graph-based recommendation service may rank and identify channels that are most relevant and/or important to the target user (u) based on generating a score for each channel (c) corresponding to a node in the set of nodes (N). A function that measures how relevant a channel (c) is to a user, such as the target user (u), may be represented as:

Score(c,u)

Further, a set of top k channels, such as the set of top k channel nodes 702 of FIG. 7, may be determined by:

Topₖ=arg max Score(c,u)

“Argmax” is a function that can be applied to Score (c, u) to identify nodes with the highest scores (i.e., nodes that are the most relevant). In some aspects, a score function may be determined for each node (n) of the set of nodes (N). The score function may be configurable based on the node's type and/or its properties. In some aspects, the score function is given by:

Score(n,u)=(Σ[w(n)×I(m)×β(n)] for all m in Γ(n))/N(n) if n in I(u) else 0

where Γ(n) is the set of nodes connected to a respective node (n) of the set of nodes. Further, w(n) is a weight determined based on what type of node (e.g., a channel node, a user node, etc.) associated with node (n). For example, in some aspects, where node (n) is a channel node, w(n) may include a privacy weight based on a privacy level of a channel corresponding to node (n) (e.g., w(n)=1 for a public channel, w(n)=10 for a private channel, and w(n)=20 for a direct message channel). In some aspects, I(m) is an influence metric for each neighbor node (m∈Γ(n)). In some aspects, β(n) is a recency and/or activity boost function associated with a recency or activity weight for a respective node (n).

One example for a channel node with a latest message timestamp (T (n)) may be represented by:

$$β ( n ) = ( exp ( \frac{τ ( n ) - c}{1 {0}^{8}} ) - SHIFT ) \times MULT$$

where c,SHIFT, and MULT are hyperparameters that can be tuned and used to normalize one or more different node weights. In particular, c, SHIFT, and MULT may be used to help ensure that β(n) is in the same magnitude as Γ(n) and w(n). If (n) is a user node, an analogous function could incorporate the user's recent login frequency, last active time, and/or other activity or recency information associated with the user's activity within the communication service.

N(n) in the score function above may be a normalization factor that depends on a node degree (e.g., 1^{st} degree, 2^{nd} degree, etc.) from user (u) and/or a user membership size associated with a channel (c). In some aspects, the normalization factor may be represented by:

$$N ( n ) = \{ \begin{matrix}log ( \vert Γ ( n ) \vert ) , & if \vert Γ ( n ) \vert \leq 1000 \\ log ( 1 {0}^{7} ) , & if \vert Γ ( n ) \vert > 1000\end{matrix}$$

In some aspects, the normalization factor is to generate a more accurate representation of relevance of each channel (n). For example, a channel that includes all users associated with the communication service, such a company-wide public channel, may not be of high relevance to a target user. However, the company-wide public channel may achieve a high relevance weight from the recommendation service because it may be a highly active channel (i.e., high activity weight) and includes every relevant user to the target user. Thus, in order to more accurately represent the relevance of a channel, the recommendation service uses a normalization factor to calculate a density of relevant vs nonrelevant users to the target user in relation to the total number of users in the channel. This density better reflects the relevance of the channel because it will yield a higher relevance weight for the channel when a higher density of relevant users is included in the channel vs. a lower density of relevant users. In some aspects, for channels with large amounts of users, the normalization factor avoids further scaling by capping the value to a maximum threshold, as indicated by the maximum threshold of 1000 in the normalization factor equation above.

In some aspects, the graph-based recommendation service further defines an influence index, I(m). An influence index/(m) may be comparable to the user relevance weight determined for a user node (e.g., as described above with respect to FIG. 6 for determining the set of top k user nodes 602, In some aspects, influence index I(m) determined for a user node (m) may be based on how many channels that user node (m) shares with target user (U). In other words, I(m) may count the overlap in channel memberships of user (m) and target user (U). A larger value of I(m) may indicate that a respective user (m) has a stronger connection to target user (U), such as by virtue of participating in more of the same channels as target user (U). In some aspects, I(m) is represented by the following:
Let ΓC(m) be the set of channels (from the set (C) of all channel nodes) that user (m) belongs to:

ΓC(m)={c in C|(m,c) in E},
where E is the set of all edges in the graph, and (m, c) refers to an edge between node m and node c.
Let ΓC(U) be the set of channels that target user (U) belongs to:

ΓC(U)={c in C|(U,c) in E}.
The influence index, I(m), is then the number of shared channels between m and U, as represented by:

I(m)=|ΓC(m)∩ΓC(U)|.

The influence index, comparable to the user relevance weight described above, can be used in the score function defined above (e.g., Score (n, u)) so that the graph-based recommendation service is able to provide both a user recommendation and a channel recommendation indicating the most relevant users and most relevant channels to a target user of the communication service.

### Example Methods for Providing Recommendations Based on a Heterogenous Graph

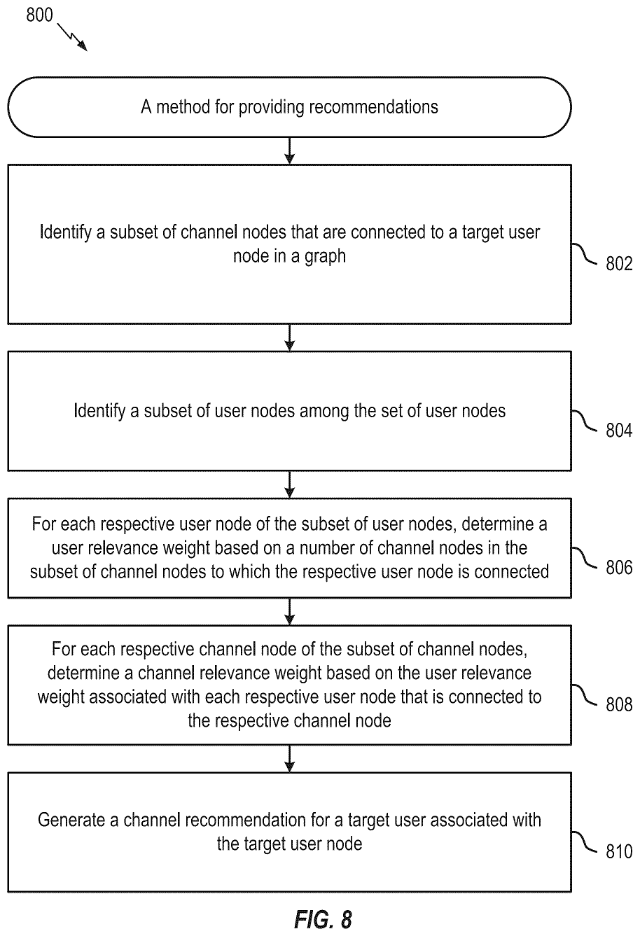

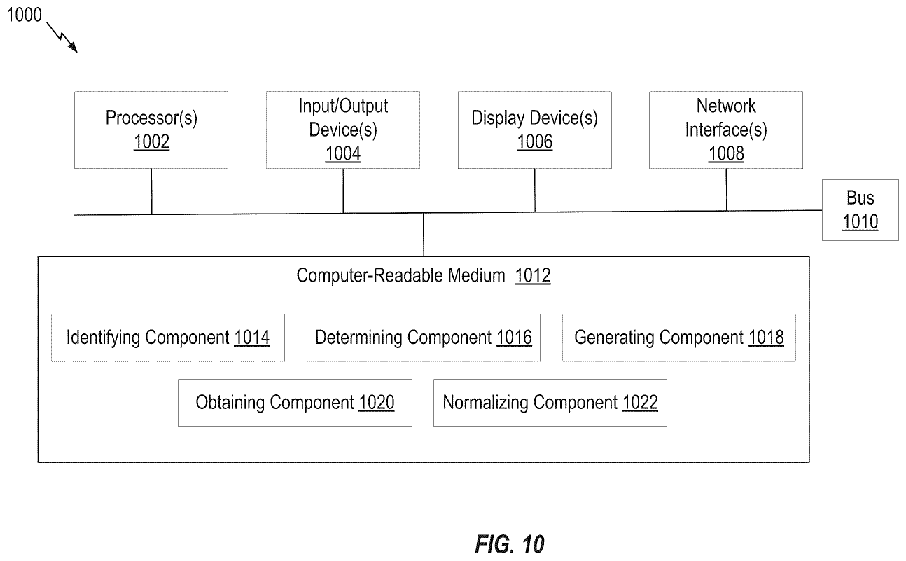

FIG. 8 depicts an example method 800 for providing recommendations based on a heterogenous graph. In one aspect, method 800 may be implemented by processing system 1000 of FIG. 10.

Method 800 starts, at block 802, with identifying a subset of channel nodes that are connected to a target user node in a graph. The graph may include a set of user nodes including the target user node, a set of channel nodes including the subset of channel nodes, and a plurality of edges connecting one or more of the set of user nodes to one or more of the set of channel nodes. In some aspects, identifying component 1014 of FIG. 10 is configured to identify a subset of channel nodes, such as the subset of channel nodes 402 of FIG. 4, associated with a target user node.

Method 800 continues, to block 804, with identifying a subset of user nodes among the set of user nodes. Each user node of the subset of user nodes may be connected to at least one channel node of the subset of channel nodes via at least one edge of the plurality of edges. In some aspects, identifying component 1014 of FIG. 10 is configured to identify a subset of user nodes, such as subset of user nodes 502 of FIG. 5, that share at least one channel node connection with a target user node.

Method 800 continues, to block 806, with determining, for each respective user node of the subset of user nodes, a user relevance weight based on a number of channel nodes in the subset of channel nodes to which the respective user node is connected. In some aspects, determining component 1016 of FIG. 10 is configured to determine user relevance weights.

Method 800 continues to block 808 with determining, for each respective channel node of the subset of channel nodes, a channel relevance weight based on the user relevance weight associated with each respective user node that is connected to the respective channel node. In some aspects, determining component 1016 of FIG. 10 is configured to determine channel relevance weights.

Method 800 continues to block 810 with generating a channel recommendation for a target user associated with the target user node. The channel recommendation may be based on the channel relevance weight associated with each channel node of the subset of channel nodes. In some aspects, generating component 1018 of FIG. 10 is configured to generate a channel recommendation, such as channel recommendation 306 of FIG. 3.

In some aspects, method 800 further includes generating a ranking for the subset of user nodes based on the user relevance weight associated with each respective user node of the subset of user nodes. In some aspects, generating component 1018 of FIG. 10 is configured to generate a ranking for a subset of user nodes, such as the subset of user nodes 502 of FIG. 5.

In some aspects, method 800 further includes generating a user recommendation for the target user, wherein the user recommendation is based on a list of users corresponding to a subset of the subset of user nodes that comprise a top k number of user nodes based on the ranking. In some aspects, generating component 1018 of FIG. 10 is configured to generate a user recommendation, such as user recommendation 302 of FIG. 3, based on top k user nodes, such as top k user nodes 602 of FIG. 6, relative to the target user node.

In some aspects, method 800 further includes generating, for display at a user interface, a list of channels corresponding to the subset of channel nodes. In some aspects, generating component 1018 of FIG. 10 is configured to generate, for display at one or more user, such as user interfaces 252(1) and/or 252(2) of FIG. 2, a list of channels, such as the list of channels 102 of FIG. 1, corresponding to the subset of channel nodes, such as channel nodes 402 of FIG. 4.

In some aspects, method 800 further includes identifying a sub-list of channels from the list of channels that correspond to a top k subset of channel nodes of the subset of channel nodes based on the channel recommendation. In some aspects, identifying component 1014 of FIG. 10 identifies a sub-list of channels from a list of channel, such as a sub-list of channels 104 from the list of channels 102 in FIG. 1, that correspond to a top k subset of channel nodes, such as the set of top k channel nodes 702 of FIG. 7.

In some aspects, method 800 further includes generating an update, for display at the user interface, based on the sub-list of channels at a top of the list of channels. In some aspects, generating component 1018 of FIG. 10 is configured to generate an update, for display at a user interface, based on the sub-list of channels at a top of the list of channels, as illustrated by channel set 106 of FIG. 1.

In some aspects, method 800 further includes determining, for each respective channel node of the subset of channel nodes, a privacy weight based on a privacy level of a channel corresponding to the respective channel node, wherein determining the channel relevance weight for the respective channel node is further based on the privacy weight. In some aspects, determining component 1016 of FIG. 10 is configured to determine privacy weights.

In some aspects, determining the channel relevance weight for the respective channel node is further based on normalizing the privacy weight and the user relevance weight for every user node that is connected to the respective channel node.

In some aspects, method 800 further includes determining, for each respective channel node of the subset of channel nodes, a recency weight based on a most recent activity associated with a channel corresponding to a respective channel node. Additionally, method 800 includes determining the channel relevance weight for the respective channel node further based on the recency weight. In some aspects, determining component 1016 of FIG. 10 is configured to determine recency weights for channel nodes.

In some aspects, method 800 further includes determining, for each respective user node of the subset of user nodes, a recency weight based on a most recent activity associated with a user corresponding to the respective user node. In some aspects, determining the user relevance weight is further based on the recency weight. In some aspects, determining component 1016 of FIG. 10 is configured to determine recency weights for user nodes.

In some aspects, method 800 further includes determining, for each respective channel node of the subset of channel nodes, an activity weight based on a frequency of activity associated with a channel corresponding to the respective channel node. Accordingly, in some aspects, determining the channel relevance weight for the respective channel node is further based on the activity weight. In some aspects, determining component 1016 of FIG. 10 is configured to determine activity weights.

In some aspects, the graph further comprises: a plurality of extrinsic data nodes; one or more first extrinsic edges connecting one or more channel nodes of the set of channel nodes to one or more extrinsic data nodes of the plurality of extrinsic data nodes; and one or more second extrinsic edges connecting one or more user nodes of the set of user nodes to one or more extrinsic data nodes of the plurality of extrinsic data nodes. In such aspects, the method 800 further comprises: identifying a set of extrinsic data nodes among the plurality of extrinsic data nodes that are connected to the target user node; for each respective channel node of the subset of channel nodes, determining an extrinsic data weight based on a number of extrinsic data nodes in the set of extrinsic data nodes that are connected to the respective channel node; and for each respective channel node of the subset of channel nodes, determining the channel relevance weight further based on the extrinsic data weight for each respective channel node. In some aspects, identifying component 1014 of FIG. 1 is configured to identify a set of extrinsic data nodes in the heterogenous graph.

Accordingly, aspects of method 800 overcome limitations associated with currently available techniques for providing recommendations using graph-based recommendation services. In particular, aspects of method 800 overcome the technical problem associated with treating all connections equally because the disclosed recommendation services treat connections between nodes differently, based on the type of node and type of relationship between the nodes. For example, nodes are weighted differently based on whether they are user nodes, channel nodes, or extrinsic nodes. Further, nodes are weighted differently based on whether the nodes are connected to other nodes of the same type or nodes of a different type (e.g., user-user, user-channel, user-extrinsic, channel-channel, or channel-extrinsic).

Additionally, while traditional graph algorithms may suffer from popularity bias, aspects of method 800 allow for customized and personalized channel recommendations for a target user that may not be the most popular, or relevant, across a larger user base because node weights are generated from the perspective of the target user. Aspects of method 800 also overcome the technical problem of failing to incorporate contextual information about users or items. In particular, because the disclosed recommender systems identify specific properties about each node the graph recommendation services described herein are able to generate property-specific node weights that help to capture temporal dynamics or situational relevance, which are helpful in delivering personalized recommendations that adapt to changing user preferences and circumstances.

Note that FIG. 8 is just one example of a method, and other methods including fewer, additional, or alternative operations are possible consistent with this disclosure.

While the aforementioned disclosure is directed to an application of the graph-based recommendation service relative to a communication service, including users and channels associated with the communication service, aspects of the graph-based recommendation service may be used to provide any type of recommendation from the perspective of a target node based on a heterogenous graph comprising at least two different types of nodes, wherein each type of node represents an entity from a list of entities.

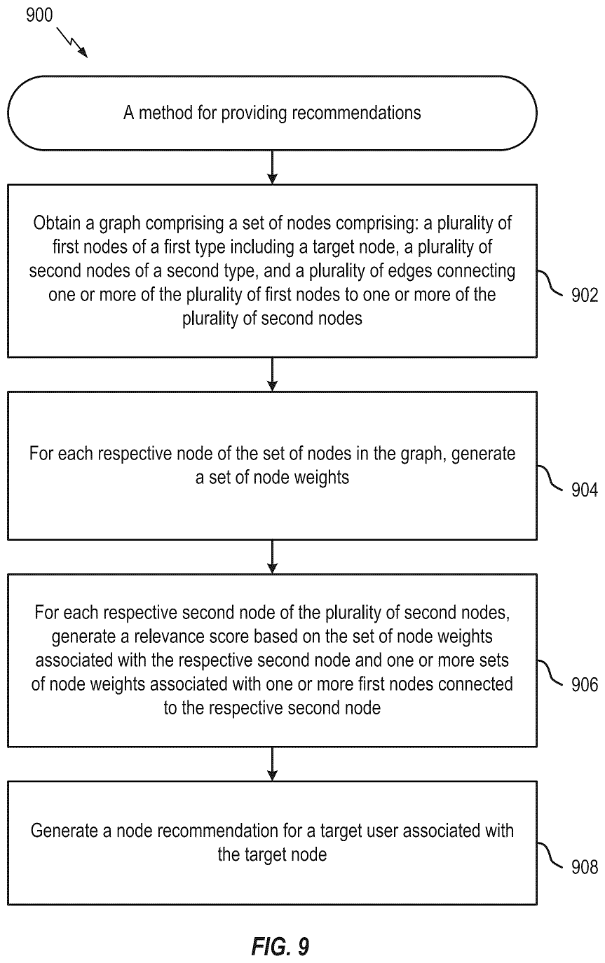

Accordingly, FIG. 9 depicts an example method 900 for providing recommendations based on a heterogenous graph comprising a plurality of different node types. In one aspect, method 900 can be implemented by the system 200 of FIG. 2 and/or processing system 1000 of FIG. 10.

Method 900 starts, at block 902, with obtaining a graph comprising a set of nodes comprising: a plurality of first nodes of a first type including a target node, a plurality of second nodes of a second type, and a plurality of edges connecting one or more of the plurality of first nodes to one or more of the plurality of second nodes. In some aspects, obtaining component 1020 of FIG. 10 is configured to obtain a heterogenous graph.

Method 900 continues, to block 904, with generating, for each respective node of the set of nodes in the graph, a set of node weights. Each respective node weight of the set of node weights is based on a respective property of a plurality of properties associated with the respective node. In some aspects, generating component 1018 of FIG. 10 is configured to generate a set of node weights for each respective node of the set of nodes in the heterogenous graph.

Method 900 continues, to block 906, with generating, for each respective second node of the plurality of second nodes, a relevance score based on the set of node weights associated with the respective second node and one or more sets of node weights associated with one or more first nodes connected to the respective second node. In some aspects, generating component 1018 of FIG. 10 is configured to generate a set of node weights for each respective node of the set of nodes in the heterogenous graph. In some aspects, generating component 1018 of FIG. 10 is configured to generate relevance scores.

Method 900 continues, to block 908, with generating a node recommendation for a target user associated with the target node. The node recommendation is based on the relevance score associated with each respective second of the plurality of second nodes. In some aspects, generating component 1018 of FIG. 10 is configured to generate a node recommendation.

In some aspects, when the respective node comprises a respective first node of the plurality of first nodes, at least one node weight of the set of node weights associated with the respective first node comprises an influence weight that is based on a number of the plurality of second nodes that are connected to the respective first node and the target node via one or more edges of the plurality of edges.

In some aspects, the graph further comprises: a plurality of third nodes of a third type; one or more edges connecting one or more second nodes to one or more third nodes; and one or more edges connecting one or more first nodes to one or more third nodes. In such aspects, the method 900 further comprises: identifying a set of third nodes among the plurality of third nodes that are connected to the target node; for each respective second node, determining a third node weight based on a number of third nodes in the set of third nodes that are connected to the respective second node; and for each respective second node, determining a fourth weight further based on the third node weight for each respective second node. In some aspects, identifying component 1014 of FIG. 10 is configured to identify a set of third nodes among the plurality of third nodes that are connected to the target node.

In some aspects, method 900 further includes normalizing each respective node weight of the set of nodes weights based on a number of first nodes connected to a node corresponding to a respective node weight. In some aspects, normalizing component 1022 of FIG. 10 is configured to normalize each respective node weight of the set of node weights.

In some aspects, method 900 further includes generating, for display at a user interface, a list of entities corresponding to the plurality of second nodes. In some aspects, generating component 1018 of FIG. 10 is configured to generate, for display at user interface 152(1) and/or user interface 152(2), a list of entities corresponding to the plurality of second nodes.

In some aspects, method 900 further includes identifying a sub-list of entities from the list of entities that correspond to a top k subset of second nodes based on the node recommendation. In some aspects, identifying component 1014 of FIG. 10 is configured to identify a sub-list of entities from the list of entities.

In some aspects, method 900 further includes generating an update, for display at the user interface, based on the sub-list of entities at a top of the list of entities. In some aspects, generating component 1018 of FIG. 10 is configured to generate an update, for display at user interface 252(1) and/or user interface 252(2) of FIG. 2, based on the sub-list of entities at the top of the list of entities.

Accordingly, aspects of method 900 overcome limitations associated with currently available techniques for ranking nodes and providing recommendations. In particular, aspects of method 800 overcome the technical problem associated with treating all connections equally because the disclosed recommendation services treat connections between nodes differently, based on the type of node and type of relationship between the nodes. Further, nodes are weighted differently based on whether the nodes are connected to other nodes of the same type or nodes of a different type.

Additionally, while traditional graph algorithms suffer from popularity bias, aspects of method 800 allow for customized and personalized recommendations for a target node that may not be the most popular, or relevant, across a larger node base. Aspects of method 800 also overcome the technical problem of failing to incorporate contextual information about certain types of entities represented by the different node types, because aspects of method 900 identify specific properties about each node, based on the type of node, and generate property-specific node weights, which are helpful in delivering personalized recommendations that adapt to changing node circumstances.

Note that FIG. 9 is just one example of a method, and other methods including fewer, additional, or alternative operations are possible consistent with this disclosure.

### Example Processing System for Providing Recommendations Based on a Heterogenous Graph

FIG. 10 depicts an example processing system 1000 configured to perform various aspects described herein, including, for example, method 800 as described above with respect to FIG. 8 and/or method 900 as described above with respect to FIG. 9.

Processing system 1000 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1000 includes one or more processor(s) 1002, one or more input/output device(s) 1004, one or more display device(s) 1006, one or more network interface(s) 1008 through which the processing system 1000 is connected to one or more networks (e.g., a local network, an intranet, the Internet, or any other group of processing systems communicatively connected to each other), and computer-readable medium 1012. In the depicted example, the aforementioned components are coupled by a bus 1010, which may generally be configured for data exchange amongst the components. Bus 1010 may be representative of multiple buses, while only one is depicted for simplicity.

Processor(s) 1002 are generally configured to retrieve and execute instructions stored in one or more memories, including local memories like computer-readable medium 1012, as well as remote memories and data stores. Similarly, processor(s) 1002 are configured to store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and/or computer-readable medium 1012. In certain embodiments, processor(s) 1002 are representative of one or more central processing units (CPUs), graphics processing unit (GPUs), tensor processing unit (TPUs), accelerators, and other processing devices.

Input/output device(s) 1004 may include any device, mechanism, system, interactive display, and/or various other hardware and software components for communicating information between processing system 1000 and a user of processing system 1000. For example, input/output device(s) 1004 may include input hardware, such as a keyboard, touch screen, button, microphone, speaker, and/or other device for receiving inputs from the user and sending outputs to the user.

Display device(s) 1006 may generally include any sort of device configured to display data, information, graphics, user interface elements, and the like to a user. For example, display device(s) 1006 may include internal and external displays such as an internal display of a tablet computer or an external display for a server computer or a projector. Display device(s) 1006 may further include displays for devices, such as augmented, virtual, and/or extended reality devices. In various embodiments, display device(s) 1006 may be configured to display a graphical user interface.

Network interface(s) 1008 provide the processing system 1000 with access to external networks and thereby to external processing systems. Network interface(s) 1008 can generally be any hardware and/or software capable of transmitting and/or receiving data via a wired or wireless network connection. Accordingly, network interface(s) 1008 can include a communication transceiver for sending and/or receiving any wired and/or wireless communication.

Computer-readable medium 1012 may be a volatile memory, such as a random-access memory (RAM), or a nonvolatile memory, such as nonvolatile random-access memory (NVRAM), or the like. In this example, computer-readable medium 1012 includes identifying component 1014, determining component 1016, generating component 1018, obtaining component 1020, and normalizing component 1022. Processing of the components 1014-1022 may enable and cause the processing system 1000 to perform the method 800 as described above with respect to FIG. 8, or any aspect related to it, and/or method 900 as described above with respect to FIG. 9, or any aspect related to it.

In certain embodiments, identifying component 1014 is configured to identify a subset of channel nodes that are connected to a target user node in a graph, the graph comprising: a set of user nodes including the target user node, a set of channel nodes including the subset of channel nodes, and a plurality of edges connecting one or more of the set of user nodes to one or more of the set of channel nodes. In certain embodiments, identifying component 1014 is configured to identify a subset of user nodes among the set of user nodes, wherein each user node of the subset of user nodes is connected to at least one channel node of the subset of channel nodes via at least one edge of the plurality of edges. In certain embodiments, determining component 1016 is configured to, for each respective user node of the subset of user nodes, determine a user relevance weight based on a number of channel nodes in the subset of channel nodes to which the respective user node is connected. In certain embodiments, determining component 1016 is configured to, for each respective channel node of the subset of channel nodes, determine a channel relevance weight based on the user relevance weight associated with each respective user node that is connected to the respective channel node. In certain embodiments, generating component 1018 is configured to generate a channel recommendation for a target user associated with the target user node, wherein the channel recommendation is based on the channel relevance weight associated with each channel node of the subset of channel nodes.

In certain embodiments, obtaining component 1020 is configured to obtain a graph comprising a set of nodes comprising: a plurality of first nodes of a first type including a target node, a plurality of second nodes of a second type, and a plurality of edges connecting one or more of the plurality of first nodes to one or more of the plurality of second nodes. In certain embodiments, generating component 1018 is configured to, for each respective node of the set of nodes in the graph, generate a set of node weights, wherein each respective node weight of the set of node weights is based on a respective property of a plurality of properties associated with the respective node. In certain embodiments, generating component 1018 is configured to, for each respective second node of the plurality of second nodes, generate a relevance score based on the set of node weights associated with the respective second node and one or more sets of node weights associated with one or more first nodes connected to the respective second node. In certain embodiments, generating component 1018 is configured to generate a node recommendation for a target user associated with the target node, wherein the node recommendation is based on the relevance score associated with each respective second of the plurality of second nodes.

Note that FIG. 10 is just one example of a processing system consistent with aspects described herein, and other processing systems having additional, alternative, or fewer components are possible consistent with this disclosure.

### EXAMPLE CLAUSES

Implementation examples are described in the following numbered clauses:
Clause 1: A method, comprising: identifying a subset of channel nodes that are connected to a target user node in a graph, the graph comprising: a set of user nodes including the target user node, a set of channel nodes including the subset of channel nodes, and a plurality of edges connecting one or more of the set of user nodes to one or more of the set of channel nodes; identifying a subset of user nodes among the set of user nodes, wherein each user node of the subset of user nodes is connected to at least one channel node of the subset of channel nodes via at least one edge of the plurality of edges; determining, for each respective user node of the subset of user nodes, a user relevance weight based on a number of channel nodes in the subset of channel nodes to which the respective user node is connected; determining, for each respective channel node of the subset of channel nodes, a channel relevance weight based on the user relevance weight associated with each respective user node that is connected to the respective channel node; and generating a channel recommendation for a target user associated with the target user node, wherein the channel recommendation is based on the channel relevance weight associated with each channel node of the subset of channel nodes.
Clause 2: The method of Clause 1, further comprising: generating a ranking for the subset of user nodes based on the user relevance weight associated with each respective user node of the subset of user nodes; and generating a user recommendation for the target user, wherein the user recommendation is based on a list of users corresponding to a subset of the subset of user nodes that comprise a top k number of user nodes based on the ranking.
Clause 3: The method of any one of Clauses 1-2, further comprising: generating, for display at a user interface, a list of channels corresponding to the subset of channel nodes; identifying a sub-list of channels from the list of channels that correspond to a top k subset of channel nodes of the subset of channel nodes based on the channel recommendation; and generating an update, for display at the user interface, based on the sub-list of channels at a top of the list of channels.
Clause 4: The method of any one of Clauses 1-3, further comprising: determining, for each respective channel node of the subset of channel nodes, a privacy weight based on a privacy level of a channel corresponding to the respective channel node, wherein determining the channel relevance weight for the respective channel node is further based on the privacy weight.
Clause 5: The method of Clause 4, wherein determining the channel relevance weight for the respective channel node is further based on normalizing the privacy weight and the user relevance weight for every user node that is connected to the respective channel node.
Clause 6: The method of any one of Clauses 1-5, further comprising: determining, for each respective channel node of the subset of channel nodes, a recency weight based on a most recent activity associated with a channel corresponding to a respective channel node, wherein determining the channel relevance weight for the respective channel node is further based on the recency weight.
Clause 7: The method of any one of Clauses 1-6, further comprising: determining, for each respective user node of the subset of user nodes, a recency weight based on a most recent activity associated with a user corresponding to the respective user node, wherein determining the user relevance weight is further based on the recency weight.
Clause 8: The method of any one of Clauses 1-7, further comprising determining, for each respective channel node of the subset of channel nodes, an activity weight based on a frequency of activity associated with a channel corresponding to the respective channel node, wherein determining the channel relevance weight for the respective channel node is further based on the activity weight.
Clause 9: The method of any one of Clauses 1-8, wherein: the graph further comprises: a plurality of extrinsic data nodes; one or more first extrinsic edges connecting one or more channel nodes of the set of channel nodes to one or more extrinsic data nodes of the plurality of extrinsic data nodes; and one or more second extrinsic edges connecting one or more user nodes of the set of user nodes to one or more extrinsic data nodes of the plurality of extrinsic data nodes, and the method further comprises: identifying a set of extrinsic data nodes among the plurality of extrinsic data nodes that are connected to the target user node; for each respective channel node of the subset of channel nodes, determining an extrinsic data weight based on a number of extrinsic data nodes in the set of extrinsic data nodes that are connected to the respective channel node; and for each respective channel node of the subset of channel nodes, determining the channel relevance weight further based on the extrinsic data weight for each respective channel node.
Clause 10: A method, comprising: obtaining a graph comprising a set of nodes comprising: a plurality of first nodes of a first type including a target node, a plurality of second nodes of a second type, and a plurality of edges connecting one or more of the plurality of first nodes to one or more of the plurality of second nodes; generating, for each respective node of the set of nodes in the graph, a set of node weights, wherein each respective node weight of the set of node weights is based on a respective property of a plurality of properties associated with the respective node; generating, for each respective second node of the plurality of second nodes, a relevance score based on the set of node weights associated with the respective second node and one or more sets of node weights associated with one or more first nodes connected to the respective second node; and generating a node recommendation for a target user associated with the target node, wherein the node recommendation is based on the relevance score associated with each respective second of the plurality of second nodes.
Clause 11: The method of Clause 10, wherein when the respective node comprises a respective first node of the plurality of first nodes, at least one node weight of the set of node weights associated with the respective first node comprises an influence weight that is based on a number of the plurality of second nodes that are connected to the respective first node and the target node via one or more edges of the plurality of edges.
Clause 12: The method of any one of Clauses 10-11, wherein: the graph further comprises: a plurality of third nodes of a third type; one or more edges connecting one or more second nodes to one or more third nodes; and one or more edges connecting one or more first nodes to one or more third nodes; and the method further comprises: identifying a set of third nodes among the plurality of third nodes that are connected to the target node; for each respective second node, determining a third node weight based on a number of third nodes in the set of third nodes that are connected to the respective second node; and for each respective second node, determining a fourth weight further based on the third node weight for each respective second node.
Clause 13: The method of any one of Clauses 10-12, further comprising normalizing each respective node weight of the set of nodes weights based on a number of first nodes connected to a node corresponding to a respective node weight.
Clause 14: The method of any one of Clauses 10-13, further comprising: generating, for display at a user interface, a list of entities corresponding to the plurality of second nodes; identifying a sub-list of entities from the list of entities that correspond to a top k subset of second nodes based on the node recommendation; and generating an update, for display at the user interface, based on the sub-list of entities at a top of the list of entities.
Clause 15: A processing system, comprising: memory comprising computer-executable instructions; and one or more processors configured to execute the computer-executable instructions and cause the processing system to perform a method in accordance with any one of Clauses 1-14.
Clause 16: A processing system, comprising means for performing a method in accordance with any one of Clauses 1-14.
Clause 17: A non-transitory computer-readable medium storing program code for causing a processing system to perform the steps of any one of Clauses 1-14.
Clause 18: A computer program product embodied on a computer-readable storage medium comprising code for performing a method in accordance with any one of Clauses 1-14.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, structure, and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
displaying on a user interface, a list of channels in a first order of channels, the list of channels corresponding to a set of channel nodes that are connected to a target user node in a graph, the graph comprising:
a set of user nodes including the target user node; and
a plurality of edges connecting one or more of the set of user nodes to one or more of the set of channel nodes;
identifying a subset of user nodes among the set of user nodes, wherein each user node of the subset of user nodes is connected to at least one channel node of a subset of channel nodes of the set of channel nodes via at least one edge of the plurality of edges;
for each respective user node of the subset of user nodes, determining a user relevance weight based on a number of channel nodes in the subset of channel nodes to which the respective user node is connected;
for each respective channel node of the subset of channel nodes, determining a channel relevance weight based on the user relevance weight associated with each respective user node that is connected to the respective channel node;
generating a channel recommendation for a target user associated with the target user node, wherein the channel recommendation is based on the channel relevance weight associated with each channel node of the subset of channel nodes;
identifying a sub-list of channels from the list of channels, the sub-list of channels corresponding to a top k subset of channel nodes of the subset of channel nodes based on the channel recommendation; and
causing the list of channels to be automatically rearranged on the user interface in a second order different than the first order, the second order having the sub-list of channels to be displayed at a top of the list of channels on the user interface, based on the channel recommendation, for interaction by the target user.

2. The method of claim 1, further comprising:
generating a ranking for the subset of user nodes based on the user relevance weight associated with each respective user node of the subset of user nodes; and
generating a user recommendation for the target user, wherein the user recommendation is based on a list of users corresponding to a subset of the subset of user nodes that comprise a top k number of user nodes based on the ranking.

3. The method of claim 1, further comprising generating an update, for display at the user interface, based on the sub-list of channels at the top of the list of channels.

4. The method of claim 1, further comprising:
for each respective channel node of the subset of channel nodes, determining a privacy weight based on a privacy level of a channel corresponding to the respective channel node,
wherein determining the channel relevance weight for the respective channel node is further based on the privacy weight.

5. The method of claim 4, wherein determining the channel relevance weight for the respective channel node is further based on normalizing the privacy weight and the user relevance weight for every user node that is connected to the respective channel node.

6. The method of claim 1, further comprising:
for each respective channel node of the subset of channel nodes, determining (1) a most recent activity via the user interface, the most recent activity comprising a most recent user interaction, on the user interface, with a channel corresponding to the respective channel node, and (2) a recency weight based on the most recent activity via the user interface,
wherein determining the channel relevance weight for the respective channel node is further based on the recency weight.

7. The method of claim 1, further comprising:
for each respective user node of the subset of user nodes, determining a recency weight based on a most recent activity associated with a user corresponding to the respective user node,
wherein determining the user relevance weight is further based on the recency weight.

8. The method of claim 1, further comprising:
for each respective channel node of the subset of channel nodes, determining an activity weight based on a frequency of activity associated with a channel corresponding to the respective channel node,
wherein determining the channel relevance weight for the respective channel node is further based on the activity weight.

9. The method of claim 1, wherein:
the graph further comprises:
a plurality of extrinsic data nodes;
one or more first extrinsic edges connecting one or more channel nodes of the set of channel nodes to one or more extrinsic data nodes of the plurality of extrinsic data nodes; and
one or more second extrinsic edges connecting one or more user nodes of the set of user nodes to one or more extrinsic data nodes of the plurality of extrinsic data nodes, and
the method further comprises:
identifying a set of extrinsic data nodes among the plurality of extrinsic data nodes that are connected to the target user node;
for each respective channel node of the subset of channel nodes, determining an extrinsic data weight based on a number of extrinsic data nodes in the set of extrinsic data nodes that are connected to the respective channel node; and
for each respective channel node of the subset of channel nodes, determining the channel relevance weight further based on the extrinsic data weight for the respective channel node.

10. A processing system, comprising: memory comprising computer-executable instructions; and one or more processors configured to execute the computer-executable instructions and cause the processing system to:
display, on a user interface, a list of channels in a first order of channels, the list of channels corresponding to a set of channel nodes that are connected to a target user node in a graph, the graph comprising:
a set of user nodes including the target user node; and
a plurality of edges connecting one or more of the set of user nodes to one or more of the set of channel nodes;
identify a subset of user nodes among the set of user nodes, wherein each user node of the subset of user nodes is connected to at least one channel node of a subset of channel nodes of the set of channel nodes via at least one edge of the plurality of edges;
for each respective user node of the subset of user nodes, determine a user relevance weight based on a number of channel nodes in the subset of channel nodes to which the respective user node is connected;
for each respective channel node of the subset of channel nodes, determine a channel relevance weight based on the user relevance weight associated with each respective user node that is connected to the respective channel node;
generate a channel recommendation for a target user associated with the target user node, wherein the channel recommendation is based on the channel relevance weight associated with each channel node of the subset of channel nodes;
identify a sub-list of channels from the list of channels, the sub-list of channels corresponding to a top k subset of channel nodes of the subset of channel nodes based on the channel recommendation; and
cause the list of channels to be automatically rearranged on the user interface in a second order different than the first order, the second order having the sub-list of channels to be displayed at a top of the list of channels on the user interface, based on the channel recommendation, for interaction by the target user.

11. The processing system of claim 10, wherein the one or more processors are further configured to cause the processing system to:
generate a ranking for the subset of user nodes based on the user relevance weight associated with each respective user node of the subset of user nodes; and
generate a user recommendation for the target user, wherein the user recommendation is based on a list of users corresponding to a subset of the subset of user nodes that comprise a top k number of user nodes based on the ranking.

12. The processing system of claim 10, wherein the one or more processors are further configured to cause the processing system to generate an update, for display at the user interface, based on the sub-list of channels at the top of the list of channels.

13. The processing system of claim 10, wherein the one or more processors are further configured to cause the processing system to:
for each respective channel node of the subset of channel nodes, determine a privacy weight based on a privacy level of a channel corresponding to the respective channel node,
wherein to cause the processing system to determine the channel relevance weight for the respective channel node, the one or more processors are configured to cause the processing system to determine the channel relevance weight for the respective channel node further based on the privacy weight.

14. The processing system of claim 13, wherein to cause the processing system to determine the channel relevance weight for the respective channel node, the one or more processors are configured to cause the processing system to determine the channel relevance weight for the respective channel node further based on normalizing the privacy weight and the user relevance weight for every user node that is connected to the respective channel node.

15. The processing system of claim 10, wherein the one or more processors are further configured to cause the processing system to:
for each respective channel node of the subset of channel nodes, determine (1) a most recent activity via the user interface, the most recent activity comprising a most recent user interaction, on the user interface, with a channel corresponding to the respective channel node, and (2) a recency weight based on the most recent activity via the user interface,
wherein to cause the processing system to determine the channel relevance weight for the respective channel node, the one or more processors are configured to cause the processing system to determine the channel relevance weight for the respective channel node further based on the recency weight.

16. A method, comprising:
displaying, on a user interface, a list of entities in a first order of entities, the list of entities corresponding to a plurality of second nodes, of a second type, that are connected to a target mode in a graph comprising a set of nodes comprising:
a plurality of first nodes, of a first type, including the target node; and
a plurality of edges connecting one or more of the plurality of first nodes to one or more of the plurality of second nodes;
for each respective node of the set of nodes in the graph, generating a set of node weights, wherein each respective node weight of the set of node weights is based on a respective property of a plurality of properties associated with the respective node;
for each respective second node of the plurality of second nodes, generating a relevance score based on the set of node weights associated with the respective second node and one or more sets of node weights associated with one or more of the plurality of first nodes connected to the respective second node;
generating a node recommendation for a target user associated with the target node, wherein the node recommendation is based on the relevance score associated with each respective second node of the plurality of second nodes;
identifying a sub-list of entities from the list of entities, the sub-list of entities corresponding to a top k subset of nodes of the plurality of second nodes based on the node recommendation; and
causing the list of entities to be automatically rearranged on the user interface in a second order different than the first order, the second order having the sub-list of entities displayed at a top of the list of entities on the user interface, based on the node recommendation, for interaction by the target user

17. The method of claim 16, wherein when the respective node comprises a respective first node of the plurality of first nodes, at least one node weight of the set of node weights associated with the respective first node comprises an influence weight that is based on a number of the plurality of second nodes that are connected to the respective first node and the target node via one or more edges of the plurality of edges.

18. The method of claim 16, wherein:
the graph further comprises:
a plurality of third nodes of a third type;
one or more edges connecting one or more of the plurality of second nodes to one or more of the plurality of third nodes; and
one or more edges connecting one or more of the plurality of first nodes to one or more of the plurality of third nodes, and
the method further comprises:
identifying a set of third nodes among the plurality of third nodes that are connected to the target node;
for each respective second node of the plurality of second nodes, determining a third node weight based on a number of third nodes in the set of third nodes that are connected to the respective second node; and
for each respective second node of the plurality of second nodes, determining a fourth weight based on the third node weight for the respective second node.

19. The method of claim 16, further comprising normalizing each respective node weight of the set of node weights based on a number of the plurality of first nodes connected to a node corresponding to the respective node weight.

20. (canceled)

21. The processing system of claim 10, wherein the one or more processors are further configured to cause the processing system to:
for each respective user node of the subset of user nodes, determine a recency weight based on a most recent activity associated with a user corresponding to the respective user node,
wherein to cause the processing system to determine the user relevance weight, the one or more processors are configured to determine the user relevance weight further based on the recency weight.
